(19) United States
(12) Patent Application Publication
(10) Pub. No.: US 2012/0235986 A1
(43) Pub. Date: Sep. 20, 2012

(54) THREE-DIMENSIONAL DISPLAY

(75) Inventors: Sheng-Ju Ho, Hsinchu City (TW); Cheng-Han Tsao, New Taipei City (TW)

(73) Assignee: AU OPTRONICS CORPORATION, Hsinchu (TW)

(21) Appl. No.: 13/158,480

(22) Filed: Jun. 13, 2011

(30) Foreign Application Priority Data
Mar. 18, 2011 (TW) 100109391

(51) Int. Cl. G06T 15/00

(52) U.S. Cl. 345/419

(57) ABSTRACT

A three-dimensional display includes a patterned phrase retarder and a three-dimensional display panel. The patterned phrase retarder includse a plurality of first bar-shaped phrase retardation regions and a plurality of second bar-shaped phrase retardation regions arranged alternately, wherein the phrase retardation of each of the first bar-shaped phrase retardation regions is different from the phrase retardation of each of the second bar-shaped phrase retardation regions. The three-dimensional display panel includes a plurality of pixels. The pixels are arranged in a plurality of pixel rows, wherein the coverage of each of the first bar-shaped phrase retardation regions corresponds to the distribution range of two adjacent pixel rows, and the coverage of each of the second bar-shaped phrase retardation regions corresponds to the distribution range of two adjacent pixel rows.

### CROSS-REFERENCE TO RELATED APPLICATION

This application claims the priority benefit of Taiwan application serial no. 100109391, filed Mar. 18, 2011. The entirety of the above-mentioned patent application is hereby incorporated by reference herein and made a part of this specification.

### BACKGROUND OF THE INVENTION

1. Field of the Invention

The invention is related to a display, and more particularly to a three-dimensional display.

2. Description of Related Art

In recent years, as display technology advances, users have become more and more demanding on display quality (such as image resolution and color saturation). However, besides high resolution and high color saturation, in order to satisfy the need of users to view realistic images, displays which are capable of displaying 3D images have been developed.

According to visual characteristics of human eyes, a 3D image may be produced when two images with basically the same content but different parallax are respectively captured by a user's left and right eyes. The parallax barrier usually uses a plurality of slits to respectively transmit the corresponding left eye image and the right eye image to the left eye and the right eye.

Currently there are many types of 3D image display technologies, one of which includes configuring a parallax barrier between the display panel and the user, and using the parallax barrier to control the left eye and right eye images received by the left and right eyes of the user. Another 3D image display technology disposes a patterned phrase retarder between the display panel and the user, and uses the combination of the patterned phrase retarder and 3D glasses to allow the left eye and right eye of the user to respectively receive the left eye image and the right eye image. Besides the above 3D image display technologies, shutter glasses may also be used so the left eye and right eye of the user can respectively receive the left eye image and the right eye image.

FIG. 1 is a schematic view of a conventional three-dimensional display using a patterned phrase retarder. Referring to FIG. 1, a conventional three-dimensional display 100 includes a patterned phrase retarder 110 and a three-dimensional display panel 120. The patterned phrase retarder 110 includes a plurality of first bar-shaped phrase retardation regions 112 and a plurality of second bar-shaped phrase retardation regions 114, wherein the first bar-shaped phrase retardation regions 112 and the second bar-shaped phrase retardation regions 114 are arranged alternately along a vertical direction, and the phrase retardation R1 of each of the first bar-shaped phrase retardation regions 112 is different from the phrase retardation R2 of each of the second bar-shaped phrase retardation regions 114. The three-dimensional display panel 120 includes a plurality of pixels 122, and the pixels 122 are arranged into a plurality of pixel rows ROW1, ROW2, wherein the pixel row ROW1 and the pixel row ROW2 are alternately arranged along a vertical direction. It should be noted that a coverage of each of the first bar-shaped phrase retardation regions 112 corresponds to a distribution range of one of the pixel rows ROW1, and a coverage of each of the second bar-shaped phrase retardation regions 114 corresponds to a distribution range of one of the pixel rows ROW2.

In the three-dimensional display 100, the pixel row ROW1 is, for example, a pixel row with an even number of rows, and the pixel row ROW2, is a pixel row with an odd number of rows. The image displayed by the pixel row ROW1 will transmit to an eye (e.g. left eye) of the user through the first bar-shaped phrase retardation region 112, and the image displayed by the pixel row ROW2 will transmit to an eye (e.g. right eye) of the user through the second bar-shaped phrase retardation region 114. When the left eye of the user receives the left eye image provided by the pixel row ROW1, the left eye of the user will synchronously receive part of the right eye image provided by the pixel row ROW2, causing image cross-talk. Image cross-talk is evident especially when the left eye of the user views the three-dimensional display panel 120 at a wide angle, causing difficulty in improving the display quality of the three-dimensional display 100.

In order to reduce the image cross-talk in the three-dimensional display 100, conventional technology has tried widening a black matrix BM width of the three-dimensional display panel 120, so the left eye of the user will have a difficult time receiving the right eye image, and the right eye of the user will have a difficult time receiving the left eye image. In other words, the user must view the three-dimensional display panel 120 at an even wider angle to notice image cross-talk. However, by widening the width of the black matrix, an aperture ratio of the three-dimensional display panel 120 is decreased, affecting the display quality of the three-dimensional display 100 in a negative way. Therefore, how to reduce image cross-talk in a three-dimensional display 100 while considering the aperture ratio of the three-dimensional display 120 is an urgent task desired to be developed.

### SUMMARY OF THE INVENTION

The invention provides a three-dimensional display that has good display quality when displaying three-dimensional images.

The invention provides a three-dimensional display including a patterned phrase retarder and a three-dimensional display panel. The patterned phrase retarder includes a plurality of first bar-shaped phrase retardation regions and a plurality of second bar-shaped phrase retardation regions, wherein the first bar-shaped phrase retardation regions and the second bar-shaped phrase retardation regions are arranged alternately. The phrase retardation of each of the first bar-shaped phrase retardation regions is different from the phrase retardation of each of the second bar-shaped phrase retardation regions. The three-dimensional display panel has a plurality of pixels. The pixels are arranged in a plurality of pixel rows, wherein a coverage of each of the first bar-shaped phrase retardation regions corresponds to a distribution range of two adjacent pixel rows, and a coverage of each of the second bar-shaped phrase retardation regions corresponds to a distribution range of two adjacent pixel rows.

In an embodiment of the invention, an extension direction of the first bar-shaped phrase retardation regions is parallel with an extension direction of the second bar-shaped phrase retardation regions, and the first bar-shaped phrase retardation regions and the second bar-shaped phrase retardation regions are alternately arranged in a direction perpendicular to the extension directions.

In an embodiment of the invention, the three-dimensional display panel further includes a plurality of scan lines and a plurality of data lines. The scan lines and the data lines are intersecting, and each of the scan lines extend in a direction substantially parallel to the extension directions of the first bar-shaped phrase retardation regions and the second bar-shaped phrase retardation regions.

In an embodiment of the invention, all the pixels of the pixel rows have the same layout.

In an embodiment of the invention, the three-dimensional display panel further includes a plurality of bar-shaped shielding patterns. The bar-shaped shielding patterns extend in a direction substantially parallel to a direction the scan lines extend. Each of the bar-shaped shielding patterns are disposed corresponding to one of the scan lines, and a distribution range of each of the bar-shaped shielding patterns are greater than a distribution range of the corresponding scan line.

In an embodiment of the invention, each bar-shaped shielding pattern partially overlaps with two adjacent pixel rows.

In an embodiment of the invention, in two pixel rows corresponding to one of the first phrase retardation regions or one of the second phrase retardation regions, each pixel of one of the pixel rows includes a first layout, each pixel of the other pixel row includes a second layout, and the first layout and the second layout are mirror images.

In an embodiment of the invention, the three-dimensional display panel further includes a plurality of bar-shaped shielding patterns. The bar-shaped shielding patterns extend in a direction substantially parallel to a direction the scan lines extend. Each of the bar-shaped shielding patterns are disposed corresponding to two of the scan lines, and a distribution range of each of the bar-shaped shielding patterns are greater than a distribution range of the corresponding scan lines.

In an embodiment of the invention, each bar-shaped shielding pattern partially overlaps with two adjacent pixel rows.

In an embodiment of the invention, the scan lines include a plurality of first scan lines and second scan lines alternately arranged to each other. Two pixel rows corresponding to each first phrase retardation region or each second phrase retardation region include a first pixel row and a second pixel row. The first pixel row is electrically connected with one of the first scan lines, and the second pixel row is electrically connected with one of the second scan lines. In each first phrase retardation region or each second phrase retardation region, the first pixel row is located between the first scan line and the second pixel row, and the second pixel row is located between the second scan line and the first pixel row. There are no scan lines between the first pixel row and the second pixel row.

In an embodiment of the invention, the three-dimensional display panel further includes a plurality of bar-shaped shielding patterns. The bar-shaped shielding patterns extend in a direction substantially parallel to a direction the first scan lines and the second scan lines extend. Each of the bar-shaped shielding patterns are disposed corresponding to one of the first scan lines and one of the second scan lines, and a distribution range of each of the bar-shaped shielding patterns are greater than a distribution range of the corresponding first scan line and second scan line.

In an embodiment of the invention, the patterned phrase retarder includes a plurality of first bar-shaped phrase retardation films and a plurality of second bar-shaped phrase retardation films. One or two first bar-shaped phrase retardation films are distributed in one of the first bar-shaped phrase retardation regions. One or two second bar-shaped phrase retardation films are distributed in one of the second bar-shaped phrase retardation regions.

In the three dimensional display panel of the invention, since the coverage of each first bar-shaped phrase retardation region corresponds to the distribution range of two adjacent pixel rows, and the coverage of each second bar-shaped phrase retardation region corresponds to a distribution range of two adjacent pixel rows, thus, the three-dimensional display panel of the invention will have good display quality when displaying three-dimensional images, and will not be prone to having the phenomenon of image cross-talk.

To make the above and other objectives, features, and advantages of the invention more comprehensible, several embodiments accompanied with figures are detailed as follows.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of a conventional three-dimensional display using a patterned phrase retarder.

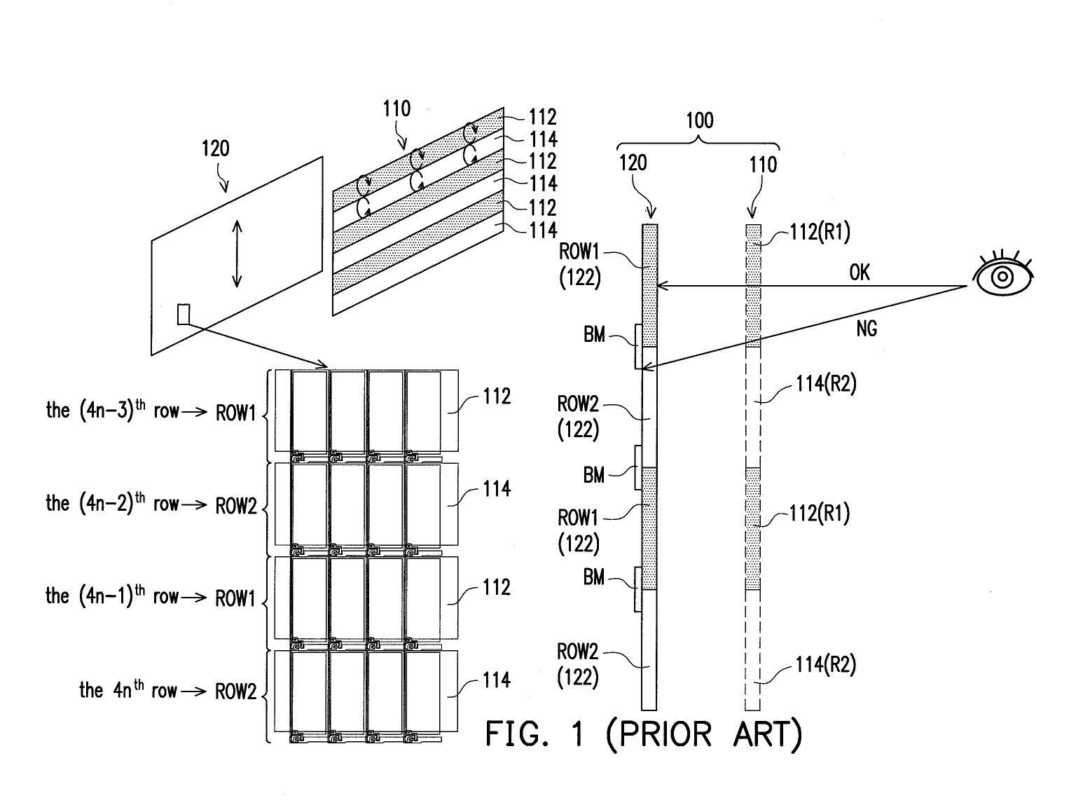

FIG. 2 is a schematic view of a three-dimensional display according to an embodiment of the invention.

FIG. 3 is a schematic view of a three-dimensional display according to another embodiment of the invention.

### DESCRIPTION OF EMBODIMENTS

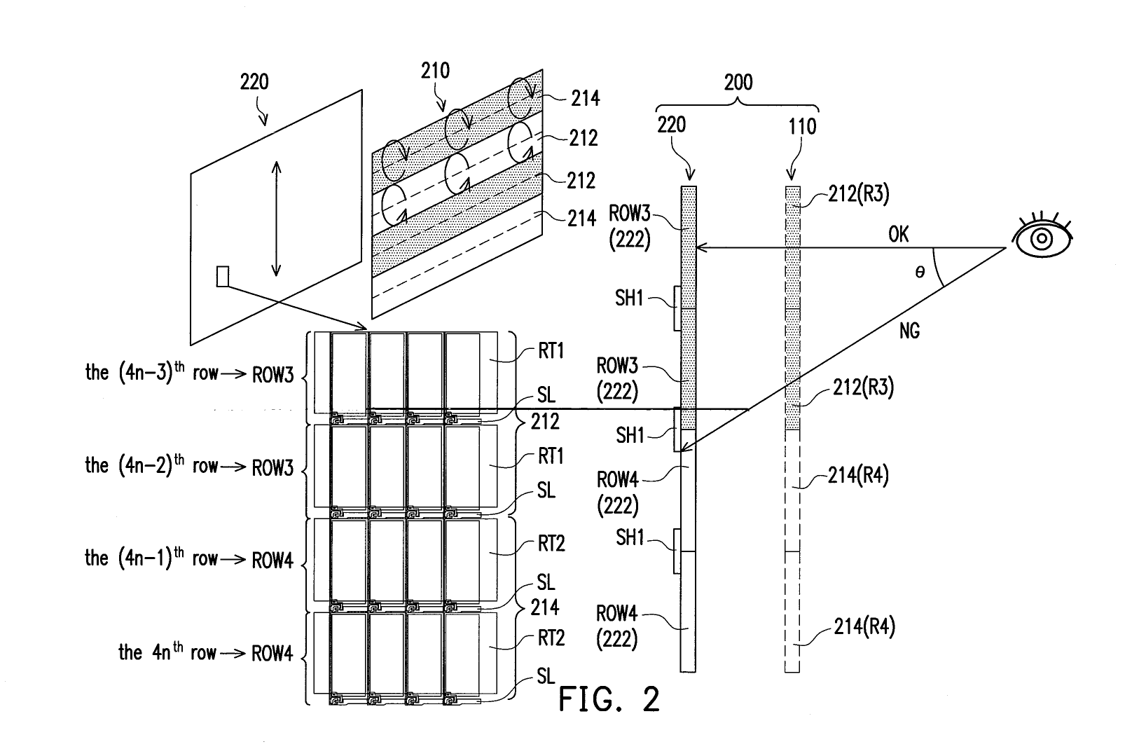

FIG. 2 is a schematic view of a three-dimensional display according to an embodiment of the invention. Referring to FIG. 2, a three-dimensional display 200 of the embodiment includes a patterned phrase retarder 210 and a three-dimensional display panel 220. The patterned phrase retarder 210 includes a plurality of first bar-shaped phrase retardation regions 212 and a plurality of second bar-shaped phrase retardation regions 214. The first bar-shaped phrase retardation regions 212 and the second bar-shaped phrase retardation regions 214 are arranged alternately, and the phrase retardation R3 of each of the first bar-shaped phrase retardation regions 212 is different from the phrase retardation R4 of each of the second bar-shaped phrase retardation regions 214. The three-dimensional display panel 220 has a plurality of pixels 222. The pixels 222 are arranged in a plurality of pixel rows ROW3, ROW4. The pixels 222 in the pixel rows ROW3, ROW4 all have, for example, the same layout. A coverage of each of the first bar-shaped phrase retardation regions 212 corresponds to a distribution range of two adjacent pixel rows ROW3, and a coverage of each of the second bar-shaped phrase retardation regions 214 corresponds to a distribution range of two adjacent pixel rows ROW4.

In detail, two first bar-shaped phrase retardation films RT1 are distributed in the same first bar-shaped phrase retardation region 212, and two second bar-shaped phrase retardation films RT2 are distributed in the same second bar-shaped phrase retardation region 214. In other words, a single first bar-shaped phrase retardation region 212 can be covered by two first bar-shaped phrase retardation films RT1. Each first bar-shaped phrase retardation film RT1 corresponds to a pixel row ROW3. A single second bar-shaped phrase retardation region 214 can be covered by two second bar-shaped phrase retardation films RT2. Each of the second bar-shaped phrase retardation films RT2 corresponds to one pixel row ROW4.

Specifically, in the embodiment, the pixels 222 arranged in the (4n-3)^{th} row and the (4n-2)^{th} row forms two pixel rows ROW3. The pixels 222 arranged in the (4n-1)^{th} row and the (4n)^{th} row forms two pixel rows ROW4, wherein n is a positive integer. In addition, the coverage of the first bar-shaped phrase retardation regions 212 corresponds to a distribution range of the two pixel rows ROW3 formed by the pixels 222 of the (4n-3)^{th} row and the (4n-2)^{th} row. The coverage of the second bar-shaped phrase retardation regions 214 corresponds to a distribution range of the two pixel rows ROW4 formed by the pixels 222 of the (4n-1)^{th} row and the (4n)^{th} row.

In the embodiment, an extension direction of the first bar-shaped phrase retardation regions 212 is parallel with an extension direction of the second bar-shaped phrase retardation regions 214, and the first bar-shaped phrase retardation regions 212 and the second bar-shaped phrase retardation regions 214 are alternately arranged in a direction perpendicular to the extension directions. In detail, the extension directions of the first bar-shaped phrase retardation regions 212 and the second bar-shaped phrase retardation regions 214 are, for example, parallel to an extension direction (i.e. row direction) of the pixel rows ROW3, ROW4. The first bar-shaped phrase retardation regions 212 and the second bar-shaped phrase retardation regions 214 are alternately arranged along a vertical direction. In further detail, the three-dimensional display panel 220 of the embodiment includes a plurality of scan lines SL and a plurality of data lines DL. The scan lines SL and the data lines DL are intersecting, and each of the scan lines SL extend in a direction substantially parallel to the extension directions of the first bar-shaped phrase retardation regions 212 and the second bar-shaped phrase retardation regions 214. In addition, the three-dimensional display panel 220 can selectively include a plurality of bar-shaped shielding patterns SH1. Each of the bar-shaped shielding patterns SH1 extend in a direction substantially parallel to a direction the scan lines SL extend. Each of the bar-shaped shielding patterns SH1 are disposed corresponding to one of the scan lines SL, and a distribution range of each of the bar-shaped shielding patterns SH1 are greater than a distribution range of the corresponding scan line SL. It should be noted that each bar-shaped shielding pattern SH1 of the embodiment will partially overlap with two adjacent pixel rows (pixel row ROW3 and pixel row ROW4, two pixel rows ROW3, or two pixel rows ROW4).

It can be seen from FIG. 2 that only when the viewer views the three-dimensional display panel 220 at a viewing angle larger than a critical angle θ will the viewer notice image cross-talk. In the embodiment, under the condition of not increasing the width of the bar-shaped shielding pattern SH1, the method of increasing the critical angle θ greatly reduces the image cross-talk phenomenon in the three-dimensional display 200.

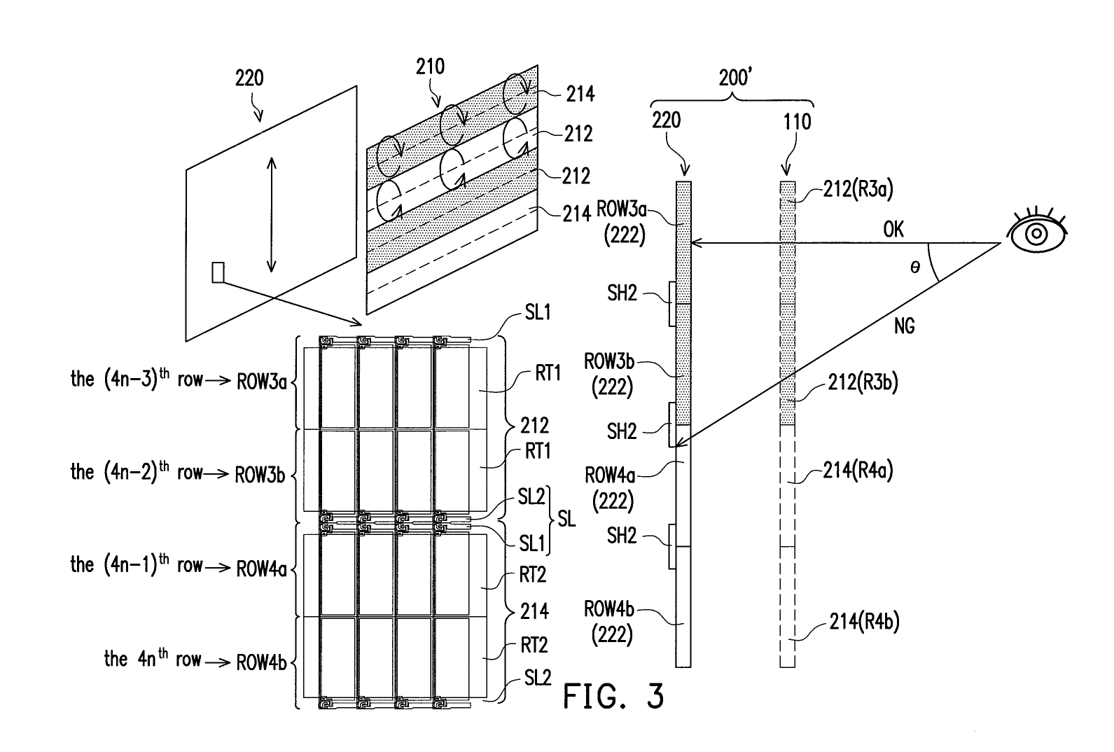

FIG. 3 is a schematic view of a three-dimensional display according to another embodiment of the invention. Referring to FIG. 3, in order to further enhance the aperture ratio of the three-dimensional display panel 220, another embodiment of the invention shows a different layout of the pixels 222 of FIG. 2. In detail, in two pixel rows ROW3 corresponding to the same first phrase retardation region 212, each of the pixels 222 of a pixel row ROW3 has a first layout, and each of the pixels 222 of the other pixel row ROW3 has a second layout. The first layout and the second layout are mirror images. Similarly, in two pixel rows ROW4 corresponding to the same second phrase retardation region 214, each of the pixels 222 of a pixel row ROW4 has a first layout, and each of the pixels 222 of the other pixel row ROW4 has a second layout. The first layout and the second layout are mirror images.

It can be seen from FIG. 3 that the three-dimensional display panel 220 can selectively include a plurality of bar-shaped shielding patterns SH2. Each of the bar-shaped shielding patterns SH2 extend in a direction substantially parallel to a direction the scan lines SL extend. Each of the bar-shaped shielding patterns SH2 are disposed corresponding to two of the scan lines SL, and a distribution range of each of the bar-shaped shielding patterns SH2 are greater than a distribution range of the two corresponding scan lines SL. In addition, each of the bar-shaped shielding patterns SH2, for example, partially overlap with two adjacent pixel rows ROW3, ROW4 (for example, the pixel row ROW3 formed by the pixels 222 arranged in the (4n-2)^{th} row, and the pixel row ROW4 formed by the pixels 222 arranged in the (4n-1)^{th} row). It should be noted that the bar-shaped shielding patterns SH2 will not be distributed in the region between the two pixel rows ROW3 corresponding to the same first phrase retardation region 212, and the bar-shaped shielding patterns SH2 will not be distributed in the region between the two pixel rows ROW4 corresponding to the same second phrase retardation region 214.

In the embodiment, the patterned phrase retarder 210 includes a plurality of first bar-shaped phrase retardation films RT1 and a plurality of second bar-shaped phrase retardation films RT2. One or two first bar-shaped phrase retardation films RT1 are selectively distributed in the same first bar-shaped phrase retardation region 212. One or two second bar-shaped phrase retardation films RT2 are selectively distributed in the same second bar-shaped phrase retardation region 214. In other words, a single first bar-shaped phrase retardation region 212 can be covered by one or two first bar-shaped phrase retardation films RT1, and a single second bar-shaped phrase retardation region 214 can be covered by one or two second bar-shaped phrase retardation films RT2.

In an embodiment of the invention, the scan lines SL include a plurality of first scan lines SL1 and second scan lines SL2 alternately arranged to each other. Two pixel rows corresponding to each first phrase retardation region 212 includes a first pixel row ROW3a and a second pixel row ROW3b. The first pixel row ROW3a is electrically connected with one of the first scan lines SL1, and the second pixel row ROW3b is electrically connected with one of the second scan lines SL2. In each first phrase retardation region 212, the first pixel row ROW3a is located between the first scan line SL1 and the second pixel row ROW3b, and the second pixel row ROW3b is located between the second scan line SL2 and the first pixel row ROW3a. There are no scan lines between the first pixel row ROW3a and the second pixel row ROW3b. Two pixel rows corresponding to each second phrase retardation region 214 includes a first pixel row ROW4a and a second pixel row ROW4b. The first pixel row ROW4a is electrically connected with one of the first scan lines SL1, and the second pixel row ROW4b is electrically connected with one of the second scan lines SL2. In each second phrase retardation region 214, the first pixel row ROW4a is located between the first scan line SL1 and the second pixel row ROW4b, and the second pixel row ROW4b is located between the second scan line SL2 and the first pixel row ROW4a. There are no scan lines between the first pixel row ROW4a and the second pixel row ROW4b.

It can be seen from FIG. 3 that the bar-shaped shielding patterns SH2 extend in a direction substantially parallel to a direction the first scan lines SL1 and the second scan lines SL2 extend. Each of the bar-shaped shielding patterns SH2 are disposed corresponding to one of the first scan lines SL1 and one of the second scan lines SL2, and a distribution range of each of the bar-shaped shielding patterns SH2 are greater than a distribution range of the corresponding first scan line SL1 and second scan line SL2.

In the three dimensional display panel of the invention, since the coverage of each first bar-shaped phrase retardation region corresponds to the distribution range of two adjacent pixel rows, and the coverage of each second bar-shaped phrase retardation region corresponds to a distribution range of two adjacent pixel rows, thus, the three-dimensional display panel of the invention will have good display quality when displaying three-dimensional images, and will not be prone to having the phenomenon of image cross-talk.

Although the invention has been disclosed by the above embodiments, they are not intended to limit the invention. Those skilled in the art may make some modifications and alterations without departing from the spirit and scope of the invention. Therefore, the protection range of the invention falls in the appended claims.

What is claimed is:

1. A three-dimensional display, comprising:
a patterned phrase retarder including a plurality of first bar-shaped phrase retardation regions and a plurality of second bar-shaped phrase retardation regions, wherein the first bar-shaped phrase retardation regions and the second bar-shaped phrase retardation regions are arranged alternately, and the phrase retardation of each of the first bar-shaped phrase retardation regions is different from the phrase retardation of each of the second bar-shaped phrase retardation regions; and
a three-dimensional display panel having a plurality of pixels, the pixels being arranged in a plurality of pixel rows, wherein a coverage of each of the first bar-shaped phrase retardation regions corresponds to a distribution range of two adjacent pixel rows, and a coverage of each of the second bar-shaped phrase retardation regions corresponds to a distribution range of two adjacent pixel rows.

2. The three-dimensional display as claimed in claim 1, wherein an extension direction of the first bar-shaped phrase retardation regions is parallel with an extension direction of the second bar-shaped phrase retardation regions, and the first bar-shaped phrase retardation regions and the second bar-shaped phrase retardation regions are alternately arranged in a direction substantially perpendicular to the extension directions.

3. The three-dimensional display as claimed in claim 2, wherein the three-dimensional display panel further includes a plurality of scan lines and a plurality of data lines, the scan lines and the data lines are intersecting, and each of the scan lines extends in a direction substantially parallel to the extension direction of the first bar-shaped phrase retardation regions and the extension direction of the second bar-shaped phrase retardation regions.

4. The three-dimensional display as claimed in claim 3, wherein all the pixels of each of the pixel rows have the same layout.

5. The three-dimensional display as claimed in claim 4, wherein three-dimensional display panel further includes a plurality of bar-shaped shielding patterns, the bar-shaped shielding patterns extend in a direction substantially parallel to a direction the scan lines extend, each of the bar-shaped shielding patterns are disposed corresponding to one of the scan lines, and a distribution range of each of the bar-shaped shielding patterns are greater than a distribution range of the corresponding scan line.

6. The three-dimensional display as claimed in claim 5, wherein each of the bar-shaped shielding patterns partially overlaps with two adjacent pixel rows.

7. The three-dimensional display as claimed in claim 3, wherein in two pixel rows corresponding to one of the first phrase retardation regions or one of the second phrase retardation regions, each pixel of one of the pixel rows includes a first layout, each pixel of the other pixel row includes a second layout, and the first layout and the second layout are mirror images.

8. The three-dimensional display as claimed in claim 7, wherein the three-dimensional display panel further includes a plurality of bar-shaped shielding patterns, the bar-shaped shielding patterns extend in a direction substantially parallel to a direction the scan lines extend, each of the bar-shaped shielding patterns are disposed corresponding to two of the scan lines, and a distribution range of each of the bar-shaped shielding patterns are greater than a distribution range of the corresponding scan lines.

9. The three-dimensional display as claimed in claim 7, wherein each bar-shaped shielding pattern partially overlaps with two adjacent pixel rows.

10. The three-dimensional display as claimed in claim 3, wherein the scan lines include a plurality of first scan lines and second scan lines alternately arranged to each other; wherein two pixel rows corresponding to each of the first phrase retardation regions or each of the second phrase retardation regions include a first pixel row and a second pixel row, the first pixel row is electrically connected with one of the first scan lines, and the second pixel row is electrically connected with one of the second scan lines; wherein in each of the first phrase retardation regions or each of the second phrase retardation regions, the first pixel row is located between the first scan line and the second pixel row, the second pixel row is located between the second scan line and the first pixel row, and there are no scan lines between the first pixel row and the second pixel row.

11. The three-dimensional display as claimed in claim 10, wherein the three-dimensional display panel further includes a plurality of bar-shaped shielding patterns, the bar-shaped shielding patterns extend in a direction substantially parallel to a direction the first scan lines and the second scan lines extend, each of the bar-shaped shielding patterns are disposed corresponding to one of the first scan lines and one of the second scan lines, and a distribution range of each of the bar-shaped shielding patterns are greater than a distribution range of the corresponding first scan line and second scan line.

12. The three-dimensional display as claimed in claim 1, wherein the patterned phrase retarder includes a plurality of first bar-shaped phrase retardation films and a plurality of second bar-shaped phrase retardation films, and one or two first bar-shaped phrase retardation films are distributed in one of the first bar-shaped phrase retardation regions, and one or two second bar-shaped phrase retardation films are distributed in one of the second bar-shaped phrase retardation regions.
